(19) United States
(12) Patent Application Publication
(10) Pub. No.: US 2010/0174062 A1
(43) Pub. Date: Jul. 8, 2010

(54) MODIFIED XANTHAN GUM, MODIFIED GUM ARABIC, AND MODIFIED TAMARIND SEED GUM, AND METHODS FOR CROSSLINKING XANTHAN GUM, GUM ARABIC, AND TAMARIND SEED GUM

(75) Inventors: Yuji Uzuhashi, Ina-shi (JP); Masaaki Kojima, Ina-shi (JP); Takehiko Sakai, Ina-shi (JP); Masao Tamada, Takasaki-shi (JP); Naotsugu Nagasawa, Takasaki-shi (JP); Akihiro Hiroki, Takasaki-shi (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: JAPAN ATOMIC ENERGY AGENCY, Ibaraki (JP)

(21) Appl. No.: 12/619,247

(22) Filed: Nov. 16, 2009

(30) Foreign Application Priority Data
Nov. 19, 2008 (JP) 2008-295572

(51) Int. Cl. C08B 37/00

(52) U.S. Cl. 536/114; 204/157.68

(57) ABSTRACT

An object is to provide a modified xanthan gum, a modified gum arabic, and a modified tamarind seed gum produced by crosslinking a naturally occurring polysaccharide such as xanthan gum, gum arabic, or tamarind seed gum, by irradiating them with radiation, and methods for crosslinking xanthan gum, gum arabic, and tamarind seed gum.

In one aspect, the invention is a modified xanthan gum produced by crosslinking xanthan gum by irradiating a solution containing 10 to 70% by weight of xanthan gum with 5 to 200 kGy of radiation. In another aspect, the invention is a modified gum arabic produced by crosslinking gum arabic by irradiating a solution containing 10 to 50% by weight of gum arabic with 5 to 200 kGy of radiation. In another aspect, the invention is a modified tamarind seed gum produced by crosslinking tamarind seed gum by irradiating a solution containing 10 to 50% by weight of tamarind seed gum with 5 to 50 kGy of radiation.

### BACKGROUND OF THE INVENTION

1. Field of the Invention

The present invention relates to modified polysaccharides produced by radiation-induced crosslinking a naturally occurring polysaccharide such as xanthan gum, gum arabic or tamarind seed gum.

2. Description of the Related Art

It has been known that a radical is generated by the application of radiation, which leads to hydrolysis reaction or crosslinking reaction on polymers. For example, it has been known that methylcellulose, carboxymethylcellulose, hydroxymethylcellulose and hydroxypropylcellulose, which are derivatives of cellulose, carboxymethylstarch which is a derivative of starch, and carboxymethylchitosan which is a derivative of chitosan, are crosslinked by the application of radiation (Japanese Patent Application Laid-Open No. 2003-160602).

### SUMMARY OF THE INVENTION

However, the production of a derivative introduced a functional group into a naturally occurring polysaccharide like cellulose needs cost and time and has a problem that the structure of the polysaccharide may change during a functional group introduction step and the like. Accordingly, an object of the present invention is to provide a modified xanthan gum, a modified gum arabic, and a modified tamarind seed gum produced by crosslinking a naturally occurring polysaccharide such as xanthan gum, gum arabic, or tamarind seed gum, by irradiating them with radiation, and methods for crosslinking xanthan gum, gum arabic, and tamarind seed gum.

The inventors studied intensively in order to achieve the object mentioned above and, as a result, they found that it is possible to crosslink xanthan gum, gum arabic, or tamarind seed gum by applying a predetermined amount of radiation in a solution containing a predetermined amount of xanthan gum, gum arabic, or tamarind seed gum. That is, the present invention is a modified xanthan gum produced by crosslinking xanthan gum by irradiating a solution containing 10 to 70% by weight of xanthan gum with 5 to 200 kGy of radiation. Moreover, the present invention is a modified gum arabic produced by crosslinking gum arabic by irradiating an aqueous solution containing 10 to 50% by weight of gum arabic with 5 to 200 kGy of radiation. Furthermore, the present invention is a modified tamarind seed gum produced by crosslinking tamarind seed gum by irradiating an aqueous solution containing 10 to 50% by weight of tamarind seed gum with 5 to 50 kGy of radiation. Furthermore, the present invention is a method for crosslinking xanthan gum, including crosslinking xanthan gum by irradiating an aqueous solution containing 10 to 70% by weight of xanthan gum with 5 to 200 kGy of radiation. Furthermore, the present invention is a method for crosslinking gum arabic, including crosslinking gum arabic by irradiating an aqueous solution containing 10 to 50% by weight of gum arabic with 5 to 200 kGy of radiation. Furthermore, the present invention is a method for crosslinking tamarind seed gum, including crosslinking tamarind seed gum by irradiating an aqueous solution containing 10 to 50% by weight of tamarind seed gum with 5 to 50 kGy of radiation.

As mentioned above, according to the present invention, it is possible to provide a modified xanthan gum, a modified gum arabic, and a modified tamarind seed gum produced by crosslinking a naturally occurring polysaccharide such as xanthan gum, gum arabic, or tamarind seed gum, by irradiating them with radiation, and methods for crosslinking xanthan gum, gum arabic, and tamarind seed gum.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein:

FIG. 1 provides a table which illustrates the effect irradiation has on strength, viscosity and swelling ratio, for a plurality of examples;

FIGS. 2 to 4 provide tables which illustrate that a lower pH tends to result in a larger swelling ratio, and a larger irradiation dose tends to result in a smaller swelling ratio; and

FIG. 5 provides a table which illustrates the effect irradiation has on film strength.

### DETAILED DESCRIPTION OF THE INVENTION

The xanthan gum to be used for the modified xanthan gum according to the present invention is contained in a solution in a content of 10 to 70% by weight, preferably 20 to 50% by weight. The gum arabic to be used for the modified gum arabic according to the present invention is contained in a solution in a content of 10 to 50% by weight, preferably 30 to 50% by weight. The tamarind seed gum to be used for the modified tamarind seed gum according to the present invention is contained in a solution in a content of 10 to 50% by weight, preferably 15 to 40% by weight, more preferably 20 to 40% by weight, and particularly preferably 30 to 40% by weight. If the amounts of xanthan gum, gum arabic, and tamarind seed gum are out of the above ranges, a crosslinking reaction does not proceed sufficiently or a decomposition reaction occurs.

The radiation to be applied to a solution containing xanthan gum, gum arabic, or tamarind seed gum is not restricted particularly, and examples thereof include ionizing radiations, such as α rays, β rays, γ rays, and X rays, and ultraviolet rays. As to the kind of ray, large particle rays like heavy ions may exert influence unevenly on the molecule of xanthan gum, gum arabic, or tamarind seed gum. Therefore, in order to complete a crosslinking reaction, the use of radiation is preferable and the use of ionizing radiation is more preferable. The ionizing radiation is preferably a γ ray emitted by cobalt-60 or an electron ray emitted by an accelerator, which are used often in the industry. Any electron accelerator may be used as long as it is capable of generating an electron ray that has an energy high enough for penetrating a sample to be irradiated. When the sample to be irradiated is as thick as 1 mm or more, a medium-energy or high-energy electron accelerator having an acceleration voltage of 1 MeV or more is preferable. When the sample to be irradiated is as thin as less than 1 mm, a low-energy electron accelerator having an acceleration voltage of 1 MeV or less may be used.

The radiation dose is 5 to 200 kGy, preferably 10 to 50 kGy for a solution containing xanthan gum, 5 to 200 kGy, preferably 50 to 200 kGy for a solution containing gum arabic, and 5 to 50 kGy, preferably 10 to 50 kGy for a solution containing tamarind seed gum. If the radiation dose is out of the above ranges, a crosslinking reaction does not proceed sufficiently or a decomposition reaction occurs.

Xanthan gum before the application of radiation preferably has a viscosity of 3,000 to 10,000 mPa·s in a 6% by weight aqueous xanthan gum solution. Such xanthan gum can be obtained by decomposing xanthan gum by applying radiation. The decomposition with radiation has less need to add an additive such as an acid in comparison to acidolysis. Since xanthan gum is decomposed by the application of radiation to have a reduced molecular weight, it becomes possible to dissolve a decomposed xanthan gum at a high concentration in a solution and, therefore, the solution can be used as a good raw material of a film, for example. When used as a raw material of a film, the solution is preferably an aqueous solution.

Gum arabic before the application of radiation preferably has a viscosity of 3,000 to 10,000 mPa·s in a 6% by weight aqueous gum arabic solution. Such gum arabic can be obtained by crosslinking gum arabic by applying radiation. Since gum arabic is crosslinked by the application of radiation to have an increased molecular weight, the workability of a solution is increased and, therefore, the solution can be used as a good raw material of a film, for example. When a film is produced from a normal gum arabic solution, the film decays into flakes. On the other hand, a crosslinked gum arabic has an increased strength and therefore it can be recovered in the form of a film. When used as a raw material of a film, the solution is preferably an aqueous solution.

Tamarind seed gum before the application of radiation preferably has a viscosity of 3,000 to 10,000 mPa·s in a 6% by weight aqueous tamarind seed gum solution. Such tamarind seed gum can be obtained by decomposing tamarind seed gum by applying radiation. Since tamarind seed gum is decomposed by the application of radiation to have a reduced molecular weight, it becomes possible to dissolve a decomposed tamarind seed gum at a high concentration in a solution and, therefore, the solution can be used as a good raw material of a film, for example. When used as a raw material of a film, the solution is preferably an aqueous solution.

For obtaining an emulsion containing xanthan gum, the solution is preferably a mixed solution composed of 30 to 90% by volume of water and 10 to 70% by volume of oil, and a mixed solution composed of 40 to 80% by volume of water and 20 to 60% by volume of oil is more preferable. An emulsion obtained in this manner is high in emulsion stability.

For obtaining an emulsion containing gum arabic, the solution is preferably a mixed solution composed of 30 to 90% by volume of water and 10 to 70% by volume of oil is preferable, and a mixed solution composed of 40 to 80% by volume of water and 20 to 60% by volume of oil is more preferable. An emulsion obtained in this manner is high in emulsion stability.

For obtaining an emulsion containing tamarind seed gum, the solution is preferably a mixed solution composed of 30 to 90% by volume of water and 10 to 70% by volume of oil is preferable, and a mixed solution composed of 30 to 50% by volume of water and 50 to 70% by volume of oil is more preferable. An emulsion obtained in this manner is high in emulsion stability.

Although the pH of a solution to be irradiated with radiation is not limited particularly, the lower the pH, the better the crosslinking advances. Therefore, for causing a crosslinking reaction, it is preferable to adjust the pH of a solution to 5 or less.

The solution to be irradiated with radiation may contain other thickening polysaccharides and the like in addition to xanthan gum, gum arabic, and tamarind seed gum to the extent that the crosslinking of xanthan gum, gum arabic, or tamarind seed gum is not inhibited. Examples of such thickening polysaccharides and the like include locust bean gum, tara gum, guar gum, glucomannan, cassia gum, fenugreek gum, karaya gum, psyllium seed gum, arabinogalactan, agar, carrageenan, sodium alginate, gellan gum, pectin, soybean polysaccharide, cellulose derivatives, gelatin, and starch.

### EXAMPLES

### Experiment Example 1-1

Next, examples of the modified xanthan gum, the modified gum arabic, and the modified tamarind seed gum according to the present invention are described. First, 30 g of xanthan gum (INAGEL V-10, produced by Ina Food Industry Co., Ltd.) was added to 70 g of ion exchanged water and mixed, and then the mixture was filled into a bag. After the filling, the xanthan gum was dissolved by heating at 120° C. for 20 minutes by the use of a retort pasteurizer. Then, the sample was γ-irradiated at 10 kGy/h for three hours (radiation dose: 30 kGy) to yield a modified xanthan gum of Example 1.

A modified gum arabic of Example 2 and a modified tamarind seed gum of Example 3 were obtained in the same manner as Example 1 except that gum arabic (INAGEL GUM ARABIC A, produced by Ina Food Industry Co., Ltd.) and tamarind seed gum (GLYLOID 6C, produced by Dainippon Sumitomo Pharma Co., Ltd.) were used instead of xanthan gum.

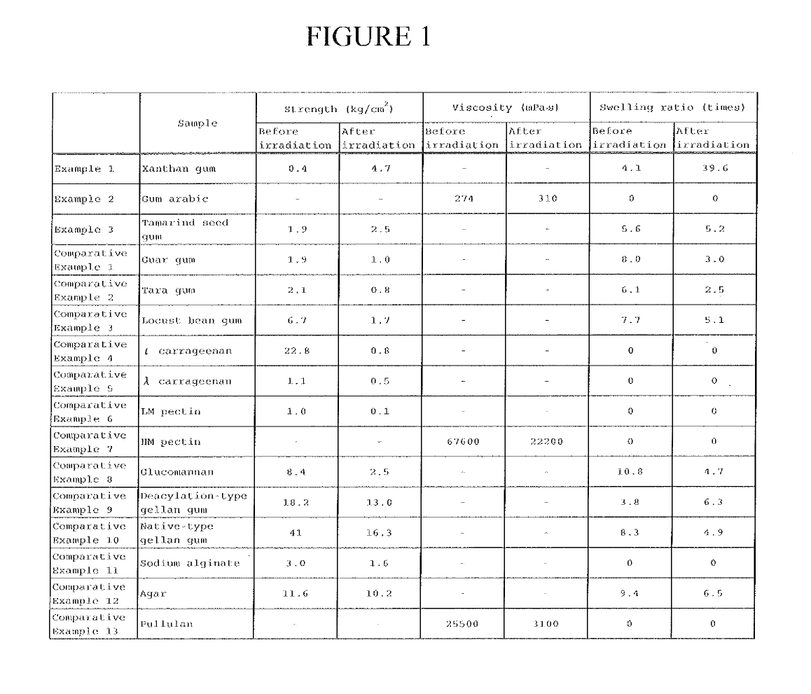

Modified samples of Comparative Examples 1 to 13 were obtained in the same manner as Example 1 except that the samples given in FIG. 1 were used instead of xanthan gum.

As for the modified xanthan gum, the modified gum arabic, and the modified tamarind seed gum obtained by Examples 1 to 3 and the modified samples obtained by Comparative Examples 1 to 13, a strength, a viscosity and a swelling ratio were determined as follows. The results are shown in FIG. 1.

### (Strength)

The rupture strength (g/cm²) was measured by using a rheometer (manufactured by Sunleo Tec Co., Ltd.). The rate of advance was 20 mm/min and the temperature of the measurement was 10° C. A plunger 3 mm in diameter was used.

### (Viscosity)

The viscosity (mPa·s) was measured using a B-type viscometer. The rate of rotation was selected from among 60 rpm, 30 rpm, 12 rpm, and 6 rpm so that a maximum rate of rotation would be achieved according to the measurement upper limit. The temperature of the measurement was 10° C. and a rotor was selected so that the code of the rotor would be the smallest code (No. 2 or No. 4) according to the measurement upper limit.

### (Swelling Ratio)

One gram of a modified sample, such as a modified xanthan gum, was immersed in 100 ml of ion exchanged water of 85° C., and it was left at rest at 85° C. for two hours. This sample was centrifuged at 12000 rpm for 15 minutes and then the amount of the resulting precipitate was measured. The swelling ratio was determined from the following formula.

(Swelling ratio)=(weight of precipitate)/(weight of modified sample)/(dispersion ratio)

FIG. 1 shows that the strength became higher or the viscosity became higher as a result of the irradiation of xanthan gum, gum arabic, and tamarind seed gum with radiation and that xanthan gum, gum arabic, and tamarind seed gum were crosslinked. As to the other samples, the strength became lower or the viscosity became lower, and this shows that the samples were decomposed.

### Experiment Example 1-2

Next, three kinds of xanthan gum different in viscosity, i.e., INAGEL V-10 (produced by Ina Food industry Co., Ltd.), INAGEL V-7 (produced by Ina Food Industry Co., Ltd.), and INAGEL SAP (produced by Ina Food Industry Co., Ltd.) were added to ion exchanged water so that their contents would become those given in Table 2, and then mixed. The mixtures were then filled into bags. After the filling, the xanthan gum was dissolved by heating at 120° C. for 20 minutes by the use of a retort pasteurizer. Then, the sample was y-irradiated at 10 kGy/h for one hour (radiation dose: 10 kGy). As for the resulting modified xanthan gums, the viscosity was measured at xanthan gum concentrations of 1 and 5% by weight, and the strength was measured at xanthan gum concentrations of 10, 20, 30, 50, and 70% by weight as follows. The results are shown in Tables 2 to 4.

### (Strength)

The rupture strength (g/cm²) was measured by using a rheometer (manufactured by Sunleo Tec Co., Ltd.). The rate of advance was 20 mm/min and the temperature of the measurement was 10° C. According to the strength, a plunger 3 mm or 20 mm in diameter was used.

### (Viscosity)

The viscosity (mPa·s) was measured using a B-type viscometer. The rate of rotation was 60 rpm and the temperature of the measurement was 10° C. As to a rotor, No. 3 or No. 4 was selected according to the viscosity.

TABLE 2

| | |
|---|---|
| Concentration of xanthan | V-10 |

| gum (% by weight) | Not irradiated | Irradiated |
|---|---|---|
| 1% | 1430 | 0 |
| 5% | >10000 | 6430 |
| 10% | 24 | 69 |
| 20% | 73 | 615 |
| 30% | 809 | 2726 |
| 50% | 8534 | 12894 |
| 70% | 26554 | 86194 |

TABLE 3

| | |
|---|---|
| Concentration of xanthan | V-7 |

| gum (% by weight) | Not irradiated | Irradiated |
|---|---|---|
| 20% | 99 | 542 |
| 30% | 1463 | 2087 |
| 50% | 30104 | 17182 |
| 70% | 30104 | 55664 |

TABLE 4

| | |
|---|---|
| Concentration of xanthan | SAP |

| gum (% by weight) | Not irradiated | Irradiated |
|---|---|---|
| 1% | 5800 | 0 |
| 5% | >10000 | 9410 |
| 10% | 43 | 67 |
| 20% | 138 | 530 |
| 30% | 497 | 1406 |
| 50% | 15194 | 23430 |
| 70% | 25844 | 33086 |

Tables 2 to 4 show that the strength became higher within the xanthan gum concentration range of 10 to 70% by weight as a result of the application of radiation, and this shows that xanthan gum was crosslinked.

### Experiment Example 1-3

Next, xanthan gum (INAGEL V-10, produced by Ina Food Industry Co., Ltd.; powder, moisture content=9.0%) was γ-irradiated at 10 kGy/h for one to five hours (radiation dose: 10 to 50 kGy). The resulting modified xanthan gum was dissolved in three portions of ion exchanged water of 20° C. so that the concentration would become 0.5% by weight, 2.0% by weight, and 6.0% by weight, respectively. After leaving them at rest for one hour, the viscosity was measured. Moreover, the solutions were heated to 80° C. and then the viscosity of each solution was measured. The viscosity was measured in the same manner as Experiment Example 1-2. The results are shown in Table 5.

TABLE 5

| | Concentration (% by weight) | | | | | |
|---|---|---|---|---|---|---|
| | 0.5% | | 2.0% | | 6.0% | |
| | Temperature | | | | | |
| | 20° C. | 80° C. | 20° C. | 80° C. | 20° C. | 80° C. |
| Not irradiated | 310 | 580 | 1480 | 4500 | >10000 | >10000 |
| 10 kGy | 75 | 17.5 | 1040 | 272.5 | >10000 | 9200 |
| 20 kGy | 25 | 12.5 | 1080 | 65 | >10000 | 7660 |
| 30 kGy | 20 | 10 | 1180 | 50 | >10000 | 6560 |
| 50 kGy | 12.5 | 7.5 | 1070 | 30 | 7290 | 5700 |

Table 5 shows that the viscosity became lower at a xanthan gum concentration of 91% by weight as a result of the application of radiation, and this shows that xanthan gum was decomposed.

### Experiment Example 1-4

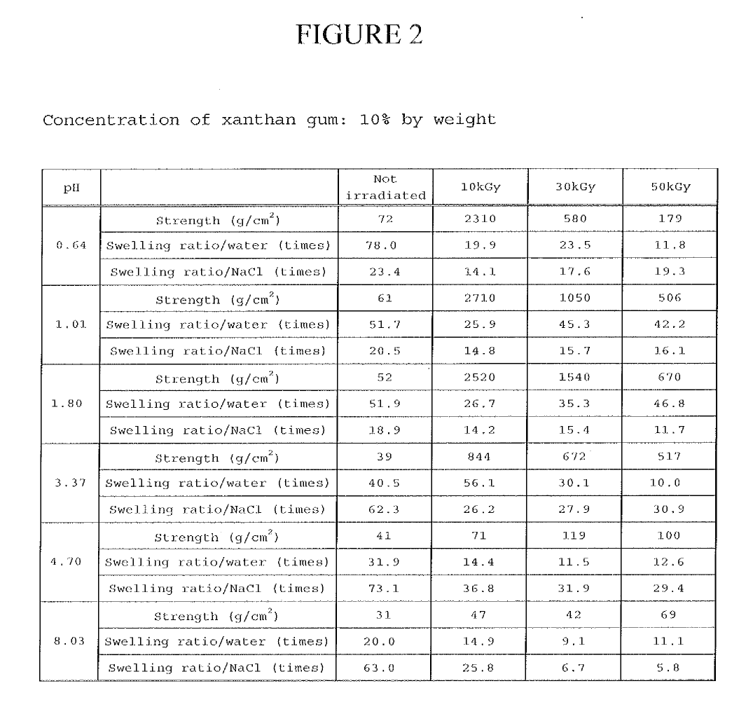

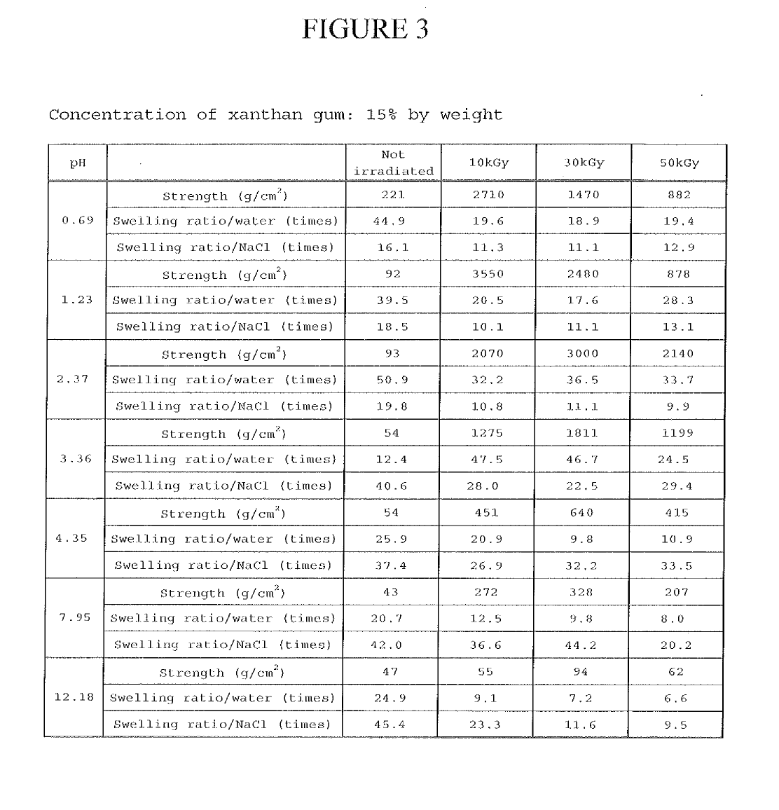

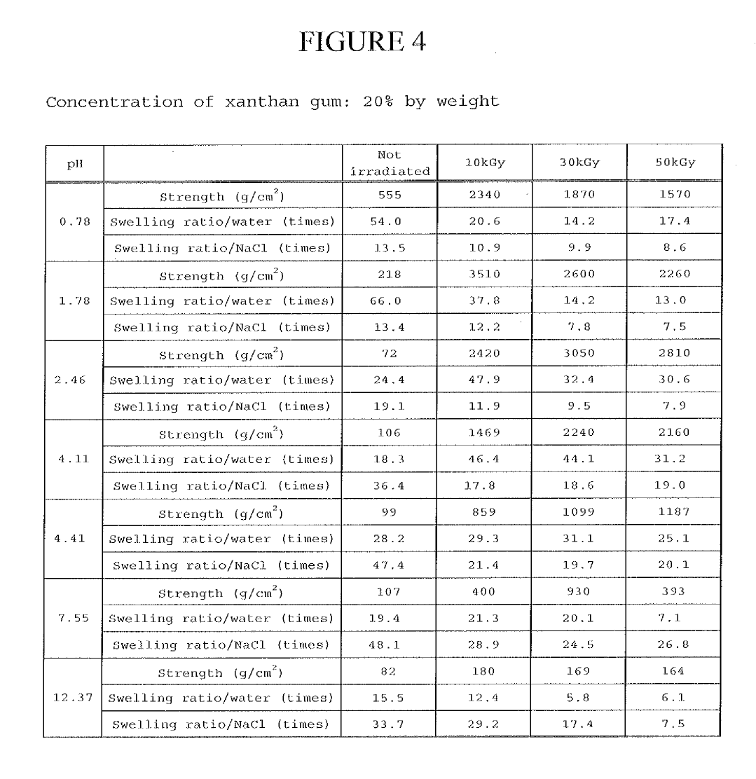

Into solutions whose pH had been adjusted with HCl or NaOH was dispersed xanthan gum (INAGEL V-10, produced by Ina Food Industry Co., Ltd.) so that the content of the dispersoid would become 10% by weight, 15% by weight, and 20% by weight, respectively. The resulting dispersions were kneaded and then were left at rest overnight. The resultant were filled into bags and then γ-irradiated at 10 kGy, 30 kGy and 50 kGy. As for the resulting modified samples, the strength and the swelling ratio were measured as follows. The results are shown in FIGS. 2 to 4.

### (Strength)

The rupture strength (g/cm²) was measured by using a rheometer (manufactured by Sunleo Tec Co., Ltd.). The rate of advance was 20 mm/min and the temperature of the measurement was 10° C. A plunger was selected (20 mm or 3 mm in diameter) according to the strength.

### (Swelling Ratio)

One gram of a modified sample was immersed in 100 ml of ion exchanged water or a 1.0% NaCl solution and then was left at rest at 20° C. overnight. This sample was centrifuged at 12000 rpm for 15 minutes and then the amount of the resulting precipitate was measured. The swelling ratio was determined from the following formula.

(Swelling ratio)=(weight of precipitate)/(weight of modified sample)/(dispersion ratio)

FIGS. 2 to 4 show that the crosslinking reaction was promoted at pH 5 or lower. It is shown that a lower pH tends to result in a larger swelling ratio and a larger irradiation dose tends to result in a smaller swelling ratio.

### Referential Experiment Example 1-1

To a 6% by weight solution of xanthan gum (INAGEL V-10, produced by Ina Food Industry Co., Ltd.) γ-irradiated with 30 kGy were added glycerin and ion exchanged water so that the concentration of glycerin would become 1.2% by weight. The mixture was heated and dissolved and it was left at rest at 80° C. overnight, thereby being degassed. A film was produced by a cast process using this dope. The moisture content of the film produced was 12% by weight. Water of an amount equivalent to 30% by weight was added to the film, and then the film was γ-irradiated with 20 kGy. As for the resulting film, the strength was measured as follows. The result is shown in Table 9.

### (Strength)

The tensile strength test was carried out by using a texture analyzer (manufactured by Eko Instruments Co., Ltd.). The tensile speed was 50 ram/min and the temperature of the measurement was 20° C. The strength was evaluated in terms of rupture strength (N).

TABLE 9

| | Before | After |
|---|---|---|
| | irradiation | irradiation |
| Film strength (N) | 7.55 | 7.96 |

It is shown that the application of 7 ray increases the strength of a film.

### Referential Experiment Example 1-2

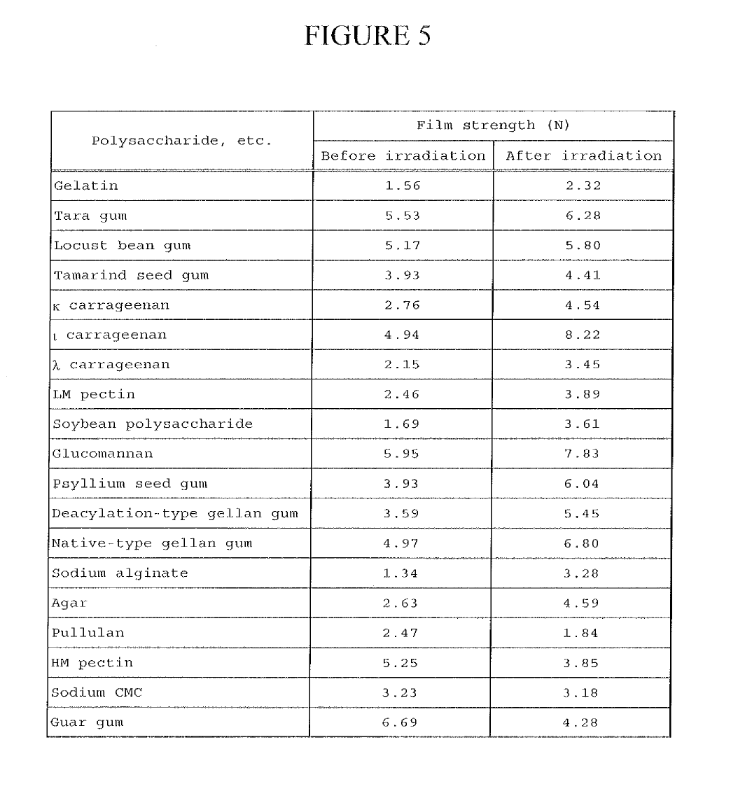

To a 4% by weight solution of xanthan gum (INAGEL V-10, produced by Ina Food Industry Co., Ltd.) γ-irradiated with 30 kGy were added a polysaccharide given in Table 10, glycerin and ion exchanged water so that the concentrations of the polysaccharide and the glycerin would become 2% by weight and 1.2% by weight, respectively. The mixture was heated and dissolved and it was left at rest at 80° C. overnight, thereby being degassed. A film was produced by a cast process using this dope. Water of an amount equivalent to 30% by weight was added to the film, and then the film was γ-irradiated with 20 kGy. As for the resulting film, the strength was measured in the same manner as Referential Experiment Example 1-1. The result is shown in FIG. 5.

It is shown that the strength can be increased by applying y ray also when thickeners other than pullulan, HM pectin, sodium CMC, and guar gum are blended to an irradiated xanthan gum.

### Referential Experiment Example 1-3

Xanthan gums (INAGEL V-10, V-7, and SAP, produced by Ina Food Industry Co., Ltd.) and locust bean gum (INAGEL L-85, produced by Ina Food Industry Co., Ltd.) were mixed at predetermined ratios (75:25, 50:50, 25:75). Then each of the mixtures was dispersed into water so that the concentration would become 30% by weight. The resulting dispersions were heated and dissolved, and then filled into bags. Thus, samples were prepared. The samples were γ-irradiated at radiation doses of 10 kGy, 30 kGy and 50 kGy. As for the resulting samples, the strength and the swelling ratio were measured in the same manners as Experiment Example 1-4. The results are shown in Tables 11 to 13.

TABLE 11
Rupture strength (g/cm²)

| | Not | | | |
|---|---|---|---|---|
| | irradiated | 10 kGy | 30 kGy | 50 kGy |
| v-10/L-85 | 2996 | 5382 | 2201 | 2641 |
| 75/25 | | | | |
| V-7/L-85 | 4445 | 2485 | 5155 | 3053 |
| 75/25 | | | | |
| SAP/L-85 | 1377 | 1292 | 2371 | 3181 |
| 75/25 | | | | |
| V-10/L-85 | 3479 | 1874 | 3351 | 3578 |
| 50/50 | | | | |
| V-7/L-85 | 4033 | 3266 | 2826 | 2485 |
| 50/50 | | | | |
| SAP/L-85 | 1590 | 1434 | 2655 | 3564 |
| 50/50 | | | | |
| V-10/L-85 | 1434 | 1860 | 2229 | 1321 |
| 25/75 | | | | |
| V-7/L-85 | 1562 | 1690 | 2073 | 1491 |
| 25/75 | | | | |
| SAP/L-85 | 1207 | 2116 | 2244 | 2400 |
| 25/75 | | | | |

TABLE 12
Degree of swelling in water (times)

| | Not | | | |
|---|---|---|---|---|
| | irradiated | 10 kGy | 30 kGy | 50 kGy |
| V-10/L-85 | 28 | 88 | 58 | 58 |
| 75/25 | | | | |
| V-7/L-85 | 32 | 114 | 70 | 73 |
| 75/25 | | | | |
| SAP/L-85 | 36 | 84 | 58 | 58 |
| 75/25 | | | | |
| V-10/L-85 | 28 | 116 | 59 | 50 |
| 50/50 | | | | |
| V-7/L-85 | 26 | 128 | 90 | 88 |
| 50/50 | | | | |
| SAP/L-85 | 42 | 76 | 54 | 50 |
| 50/50 | | | | |
| V-10/L-85 | 27 | 48 | 25 | 49 |
| 25/75 | | | | |
| V-7/L-85 | 11 | 47 | 39 | 32 |
| 25/75 | | | | |
| SAP/L-85 | 110 | 58 | 44 | 40 |
| 25/75 | | | | |

TABLE 13
Degree of swelling in NaCl (times)

| | Not | | | |
|---|---|---|---|---|
| | irradiated | 10 kGy | 30 kGy | 50 kGy |
| V-10/L-85 | 68 | 22 | 9 | 8 |
| 75/25 | | | | |
| V-7/L-85 | 50 | 22 | 12 | 11 |
| 75/25 | | | | |
| SAP/L-85 | 30 | 19 | 10 | 9 |
| 75/25 | | | | |
| V-10/L-85 | 47 | 15 | 11 | 9 |
| 50/50 | | | | |
| V-7/L-85 | 48 | 17 | 10 | 9 |
| 50/50 | | | | |
| SAP/L-85 | 24 | 15 | 8 | 7 |
| 50/50 | | | | |
| V-10/L-85 | 25 | 13 | 8 | 7 |
| 25/75 | | | | |
| V-7/L-85 | 27 | 13 | 9 | 8 |
| 25/75 | | | | |
| SAP/L-85 | 17 | 10 | 7 | 6 |
| 25/75 | | | | |

### Experiment Example 2-1

First, 20 g of gum arabic (INAGEL GUM ARABIC A, produced by Ina Food Industry Co., Ltd.) was added to 80 g of ion exchanged water and mixed, and then the mixture was filled into a bag to prepare a 20% by weight solution. Similarly, 50 g of gum arabic was dissolved in 50 g of ion exchanged water to prepare a 50% by weight solution. After the filling, the gum arabic was dissolved by heating at 120° C. for 20 minutes by the use of a retort pasteurizer. Then, the sample was γ-irradiated at 10 kGy/h for 5 to 20 hours (radiation dose: 50 to 200 kGy). As for the resulting modified gum arabic, the viscosity was measured at a gum arabic concentration of 20% by weight, and the viscosity or strength and the swelling ratio were measured at a xanthan gum concentration of 50% by weight as follows. The results are shown in Table 14.

### (Strength)

The rupture strength (g/cm²) was measured by using a rheometer (manufactured by Sunleo Tec Co., Ltd.). The rate of advance was 20 mm/min and the temperature of the measurement was 10° C. A plunger 10 mm in diameter was used.

### (Viscosity)

The viscosity was measured by using a B-type viscometer. The rate of rotation was 60 rpm and the temperature of the measurement was 10° C. A rotor was selected from among No. 2, No. 3 and No. 4 according to the viscosity.

### (Swelling Ratio)

One gram of a modified gum arabic was added to ion exchanged water of 20° C., and the mixture was left at rest for 24 hours. This was filtered with a mesh #16 and the collected residue was weighed. Thus, a magnification of weight increment was calculated and a swelling ratio (times) was determined.

TABLE 14

| 20% solution | 50% solution | | |
|---|---|---|---|
| Viscosity | Viscosity | Strength | Swelling |
| (mPa · s) | (mPa · s) | (g/cm²) | ratio |

| | | | | |
|---|---|---|---|---|
| Not irradiated | 80 | 1100 | — | — |
| 50 kGy | 175 | 7400 | — | — |
| 100 kGy | 205 | >10000 | — | — |
| 200 kGy | 275 | — | 239 | 7.86 |

Table 14 shows that the viscosity or the strength became higher as a result of the application of radiation at a gum arabic concentration of 20% by weight or 50% by weight, and this shows that gum arabic was crosslinked.

### Experiment Example 2-2

Next, 1 g of gum arabic (INAGEL GUM ARABIC A, produced by Ina Food Industry Co., Ltd.) was added to 99 g of a mixed liquid of water and oil (volume ratio=50:50) and mixed. Then the mixture was filled into a bag to prepare a 1% by weight solution. In a similar manner, 5 g of gum arabic was dissolved into 95 g of a mixed liquid to produce a 5% by weight solution, 10 g of gum arabic was dissolved into 90 g of a mixed liquid to produce a 10% by weight solution, and 20 g of gum arabic was dissolved into 80 g of a mixed liquid to produce a 20% by weight solution. These solutions were stirred at 10000 rpm for 10 minutes with a TK homogenizer. Then, γ ray was applied at 10 kGy/h for 5 to 20 hours (radiation dose: 50 to 200 kGy). As for the resulting emulsified compositions, the viscosity or the strength and the swelling ratio were measured as follows. The results are shown in Table 15.

### (Strength)

The rupture strength (g/cm²) was measured by using a rheometer (manufactured by Sunleo Tec Co., Ltd.). The rate of advance was 20 mm/min and the temperature of the measurement was 10° C. A plunger 10 mm in diameter was used.

### (Viscosity)

The viscosity was measured by using a B-type viscometer. The rate of rotation was 60 rpm and the temperature of the measurement was 10° C. A rotor was selected from among No. 2, No. 3 and No. 4 according to the viscosity.

### (Swelling Ratio)

One gram of a modified gum arabic was added to ion exchanged water of 20° C., and the mixture was left at rest for 24 hours. This was filtered with a mesh #16 and the collected residue was weighed. Thus, a magnification of weight increment was calculated and a swelling ratio (times) was determined.

TABLE 15

| Concentration | | Not | 50 | 100 | 200 |
|---|---|---|---|---|---|
| of gum arabic | | irradiated | kGy | kGy | kGy |
| 1% by weight | Viscosity | 560 | 420 | 250 | 270 |
| | (mPa · s) | | | | |
| | Strength | — | — | — | — |
| | (g/cm²) | | | | |
| 5% by weight | Viscosity | 1370 | 1290 | 1670 | 1310 |
| | (mPa · s) | | | | |
| | Strength | — | — | — | — |
| | (g/cm²) | | | | |
| 10% by weight | Viscosity | 1530 | 4060 | 4800 | — |
| | (mPa · s) | | | | |
| | Strength | — | — | — | 8 |
| | (g/cm²) | | | | |
| 20% by weight | Viscosity | 2100 | — | — | — |
| | (mPa · s) | | | | |
| | Strength | — | 30 | 72 | 80 |
| | (g/cm²) | | | | |
| | Swelling ratio | — | 0.98 | 1.26 | 2.64 |
| | (times) | | | | |

Table 15 shows that the viscosity or the strength became higher as a result of the application of radiation within a range where the gum arabic concentration is 10% by weight or more, and this shows that gum arabic was crosslinked.

### Experiment Example 2-3

Next, 20 g of gum arabic (INAGEL GUM ARABIC A, produced by Ina Food Industry Co., Ltd.) was added to 80 g of each of three mixed liquids of water and oil (volume ratio=90:10, 80:20, and 50:50) and mixed. Then the respective mixtures were filled into bags to prepare 200 by weight solutions. These solutions were stirred at 10000 rpm for 10 minutes with a TK homogenizer. Then, γ ray was applied at 10 kGy/h for 5 to 20 hours (radiation dose: 50 to 200 kGy). As for the resulting emulsified compositions, the viscosity or the strength was measured in the same manners as Experiment Example 2-2. The results are shown in Table 16.

TABLE 16

| | | Not | | | |
|---|---|---|---|---|---|
| Water:oil | | irradiated | 50 kGy | 100 kGy | 200 kGy |
| 90:10 | Viscosity | 510 | 480 | 410 | 640 |
| | (mPa · s) | | | | |
| | Strength | — | — | — | — |
| | (g/cm²) | | | | |
| 80:20 | Viscosity | 490 | 640 | 1370 | — |
| | (mPa · s) | | | | |
| | Strength | — | — | — | 6 |
| | (g/cm²) | | | | |
| 50:50 | Viscosity | >10000 | — | — | — |
| | (mPa · s) | | | | |
| | Strength | — | 67 | 151 | 131 |
| | (g/cm²) | | | | |

Table 16 shows that the viscosity or the strength became higher as a result of the application of radiation at 200 kGy in the solutions containing 20% by volume of oil, and this shows that gum arabic was crosslinked.

### Experiment Example 3-1

Next, 30 g of tamarind seed gum (GLYLOID 6C, produced by Dainippon Sumitomo Pharma Co., Ltd.) was added to 70 g of ion exchanged water and mixed. Then the mixture was filled into a bag to prepare a 30% by weight solution. After the filling, the tamarind seed gum was dissolved by heating at 120° C. for 20 minutes by the use of a retort pasteurizer. Then, γ ray was applied at 10 kGy/h for 1 to 22 hours (radiation dose: 10 to 220 kGy). As for the resulting modified tamarind seed gums, the strength was measured as follows. The results are shown in Table 17.

### (Strength)

The rupture strength (g/cm²) was measured by using a rheometer (manufactured by Sunleo Tec Co., Ltd.). The rate of advance was 20 mm/min and the depth of advance was 10 mm. The plunger was 3 mm in diameter and the temperature of the measurement was 10° C.

TABLE 17

| | Not | | | |
|---|---|---|---|---|
| | irradiated | 10 kGy | 50 kGy | 220 kGy |
| Strength | 134 | 243 | 681 | 46 |
| (g/cm²) | | | | |

The applications of γ ray at 10 kGy and 50 kGy increased the strength in comparison to that resulting from no application of radiation. This shows that the samples were crosslinked.

### Experiment Example 3-2

Into a solution whose pH had been adjusted with HCl or NaOH was dispersed tamarind seed gum (GLYLOID 6C, produced by Dainippon Sumitomo Pharma Co., Ltd.) so that the content of the dispersoid would become 15% by weight. The resulting dispersion was kneaded and then left at rest overnight. The resultant was filled into bags and then irradiated with γ ray at 10 kGy, 30 kGy and 50 kGy. As for the resulting modified samples, the strength and the swelling ratio were determined in the same manners as Experiment Example 1-4 and the viscosity was determined in the same manner as Experiment Example 1-2. The results are shown in Table 18.

TABLE 18

| | | Not | | | |
|---|---|---|---|---|---|
| pH | | irradiated | 10 kGy | 30 kGy | 50 kGy |
| 2.06 | Strength (g/cm²) | 81 | 87 | 675 | 261 |
| | Swelling ratio/water | 0.0 | 20.9 | 20.8 | 16.6 |
| | (times) | | | | |
| | Swelling ratio/NaCl | 0.0 | 21.8 | 17.3 | 17.5 |
| | (times) | | | | |

Table 18 shows that a crosslinking reaction has proceeded.

What is claimed is:

1. A modified xanthan gum produced by crosslinking xanthan gum by irradiating a solution containing 10 to 70% by weight of xanthan gum with 5 to 200 kGy of radiation.

2. A method for crosslinking xanthan gum, comprising crosslinking xanthan gum by irradiating a solution containing 10 to 70% by weight of xanthan gum with 5 to 200 kGy of radiation.

3. A modified gum arabic produced by crosslinking gum arabic by irradiating an aqueous solution containing 10 to 50% by weight of gum arabic with 5 to 200 kGy of radiation.

4. A method for crosslinking gum arabic, comprising crosslinking gum arabic by irradiating an aqueous solution containing 10 to 50% by weight of gum arabic with 5 to 200 kGy of radiation.

5. A modified tamarind seed gum produced by crosslinking tamarind seed gum by irradiating a solution containing 10 to 50% by weight of tamarind seed gum with 5 to 50 kGy of radiation.

6. A method for crosslinking tamarind seed gum, comprising crosslinking tamarind seed gum by irradiating an aqueous solution containing 10 to 50% by weight of tamarind seed gum with 5 to 50 kGy of radiation.
